(19) United States
(12) Patent Application Publication
(10) Pub. No.: US 2008/0296090 A1
(43) Pub. Date: Dec. 4, 2008

(54) Gripping Apparatus

(76) Inventors: Steven Hepworth, Morley Leeds (GB); Arthur Sharp, Belle Isle Leeds (GB)

Correspondence Address: Audrey A. Millemann;Weintraub Genshlea Chediak, 400 Capitol Mall, 11th Floor, Sacramento, CA, 95814, US

(21) Appl. No.: 10/594,354

(22) PCT Filed: Mar. 22, 2005
(86) PCT No.: PCT/GB2005/001083

§ 371 Date: Mar. 22, 2008

(30) Foreign Application Priority Data
Mar. 26, 2004 (GB) 0406784.9

(51) Int. Cl. B25H 1/06; E04G 1/34

(52) U.S. Cl. 182/186.2

(57) ABSTRACT

A gripping apparatus comprising a pair of interchangeable gripping members (12, 24) each mounted on support members (4, 6) at a first end thereof, pivoting means connecting each of the support members at a location offset from the gripping members, where the distal ends (8) of one of the support members (4) is moveable across a supporting surface, the distal ends (28) of the other support member (6) providing resistance to such movement, such that the weight of the apparatus and/or application of a downwards force on the apparatus moves the distal ends (8) of the support member (4) away from the distal ends (28) of the other support member (6), pivoting the gripping members (12, 24) towards each other to exert a grip on a workpiece (34) positioned between the gripping members (12, 24).

The invention to which this application relates is a gripping apparatus for gripping a workpiece.

Although the following description refers almost exclusively to use of a gripping apparatus for sawing wood, it will be appreciated by persons skilled in the art that the present invention can be used to hold other materials and/or for other purposes, such as filing, drilling and the like.

It is well known to use a clamp or vice for holding a piece of wood or metal in place while an operator works on the same, for example with a saw. Clamps typically have a pair of jaws mounted on a threaded member. The material is placed in the jaws, and the jaws are then moved towards each other, usually by rotating a handle to move one of the jaws along the threaded member towards the other jaw. The more the handle is rotated, the firmer the material is gripped. The tighter the thread in such an arrangement, the higher the gripping force applied to the material, as a greater rotational movement is required to move the jaw a specific distance. However, a disadvantage of a tight thread is that a large number of handle rotations is required to open and close the jaws, which is time consuming and laborious.

An example of a product which includes this arrangement is the Black and Decker Workmate (Registered Trade Mark) which typically features one or more clamps as described above mounted on a frame.

An aim of the present invention is to provide a gripping apparatus which is not laborious to operate, and further, to provide a gripping apparatus which is simple in construction.

In a first aspect of the invention, there is provided a gripping apparatus comprising two or more gripping members each mounted on support means at a first end thereof, and pivoting means connecting the support means at a location offset from the gripping members, such that the gripping members are moved towards each other to exert a grip on a workpiece positioned between the same as the distal ends of the support means are moved apart.

Typically the members on which the pivoting means is mounted are angled towards the surface and/or distal ends of the support means such that once the space between the distal ends extends beyond a certain distance the members act to bias the gripping members towards each other and hence make movement of the device easier and also serve to increase the gripping force applied to the workpiece and/or make it less likely that the gripping members will be forced apart during use or when performing an operation on the workpiece held between the same.

Typically, the distal ends are in contact with a support surface at least during the gripping of the workpiece.

Typically movement means are provided on the distal end or ends of at least one support means to engage the support surface.

In a preferred embodiment, a further support means are provided with resistance means to engage the support surface such that movement may be restricted by friction.

Preferably the resistance means includes any or any combination of rubber feet, locks, screws, bolts, weights, abrasive materials, protrusions and/or the like.

Preferably the movement means are any or any combination of wheels, rollers, bearings, slides, and or the like.

Preferably each support means is provided in the form of a frame having one or more support members.

Preferably the members are any or any combination of tubes, struts, or other resilient members and/or the like.

Typically the device includes one or more workpiece support members onto which a workpiece can be rested when not gripped by the gripping members.

In one embodiment the workpiece support members are extend able.

Typically the apparatus moves between an open state wherein the gripping members are substantially apart and the support means connected to each gripping member are closer together, and a closed state wherein the gripping members are substantially together and the support means connected to each gripping member are further apart than in the open state.

Preferably, the apparatus assumes a closed state when placed on a supporting surface under its own weight and/or when a downwards or other force is applied to the apparatus.

Preferably an open state is induced when the apparatus is lifted from the supporting surface.

This allows the apparatus to be stored in a more compact form when lifted completely off the surface.

Preferably the apparatus can be lifted without removal from the surface to allow the insertion of a workpiece between the gripping members.

Preferably the workpiece is gripped by the gripping members when the apparatus is released and allowed to assume its natural state under its own weight.

Typically the gripping force on the workpiece can be increased by providing downwards or other force to the apparatus.

A downwards or other force may cause the support means to move apart from each other further, thereby causing the gripping members to move towards each other, thereby increasing the gripping force on the workpiece therebetween.

In one embodiment the apparatus is provided with pivoting means mounted on members to connect the support means. These members and pivoting means increase stability of the apparatus.

Typically one or more of the members are provided with a plate to allow a user to apply downwards force thereto. A user can step on the plate to increase the downwards force applied to the apparatus and the grip exerted on the workpiece.

Preferably the members and/or plate are angled towards the first ends of the support means, to allow a user to effectively apply force thereto.

Preferably the gripping members are detachably connected to the support means.

Preferably the gripping members can be provided in different shapes and materials, and are interchangeable as necessary depending on the nature of the workpiece being held between the gripping members.

Gripping members could be provided at least partly made from materials such as rubber, wood, metal to provide different gripping characteristics. Similarly, the gripping members could be concave, convex, include recesses or be otherwise shaped to suit the workpiece held therebetween.

The gripping members can also be combined in different ways to suit the workpiece being held.

Preferably the gripping members and support means are provided with attachment means and/or complimentary receiving means to allow the interengagement of the gripping members and support means.

Preferably the attachment means and receiving means are tubular, the tubes fitting together concentrically.

Alternatively the attachment means and receiving means dovetail together, such that the gripping members can be slidably mounted on the support members.

The attachment means may also include any or any combination of screws, nuts, bolts, latches, wedges, locks, and/or the like.

In an alternative embodiment the pivoting means includes a first member connected to first support means via locking means, a second member connected to second support means, the first member pivotally connected to the second member.

Typically the locking means comprises a slot in the first member and a locking member extending therethrough and capable of sliding along the slot. The locking means allows at least part of the support means to be locked in a particular position and/or allows the support means to slide over each other.

Typically the top portions of the first and/or second support means which include the gripping members are hingedly separated from the bottom portions which include the pivoting means by hingeing means.

Typically the hingeing means allow the gripping members to move between an open state and a closed state without concomitant movement of the bottom portions, when at least part of the support means is locked by the locking means. The top portions are restricted in movement by the acute angle between the opposite faces of the top and bottom portions of the support means thereat.

Typically when the locking means unlocks the frames, allowing the locking member to slide along the slot, the opposite faces of the top and bottom portions can engage and move the gripping members to a closed state by pivoting about the pivot means.

Specific embodiments of the invention are now described wherein:—

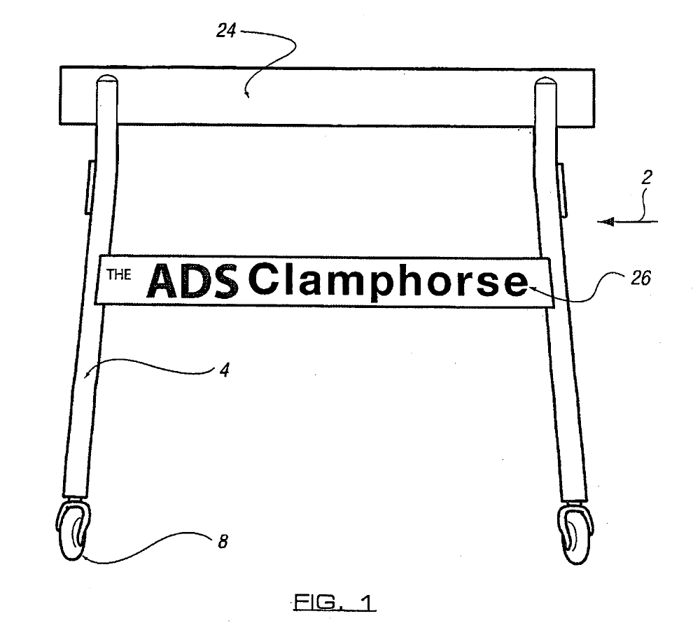

FIG. 1 illustrates a front view of a gripping apparatus.

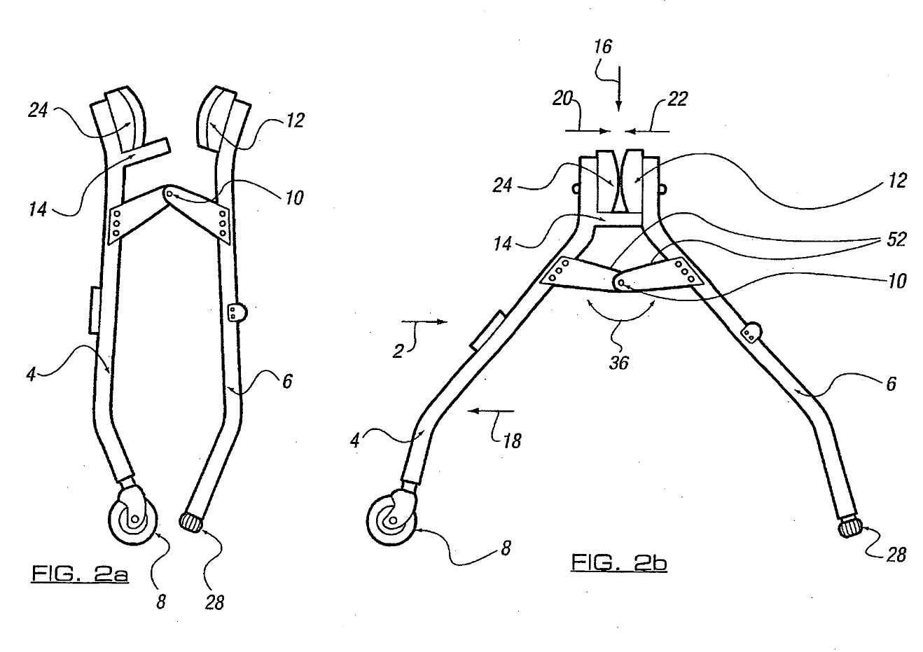

FIGS. 2a-b illustrate a side view of a gripping apparatus in (a) an open state and (b) a closed state.

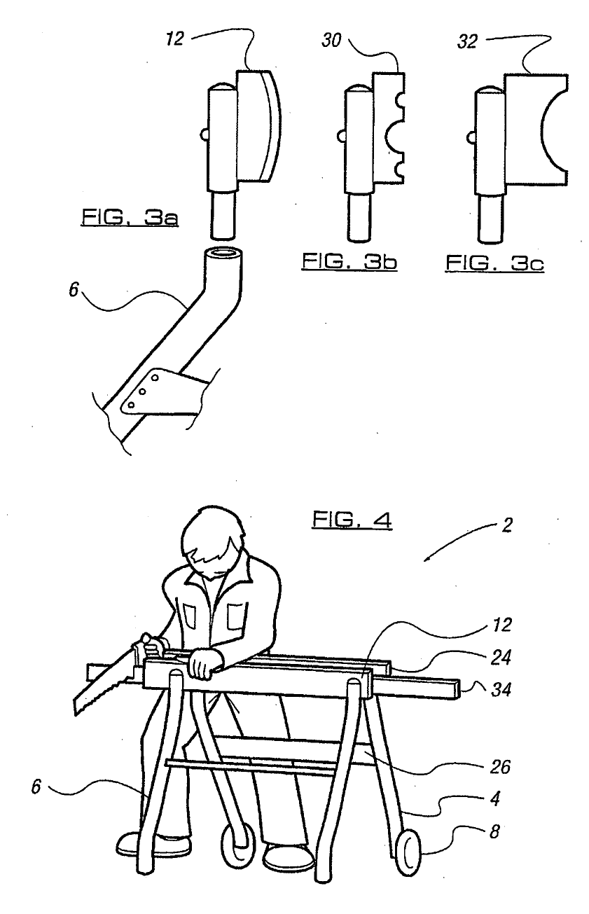

FIGS. 3a-c illustrate several interchangeable jaws for a gripping apparatus.

FIG. 4 illustrates a perspective view of a gripping apparatus in use.

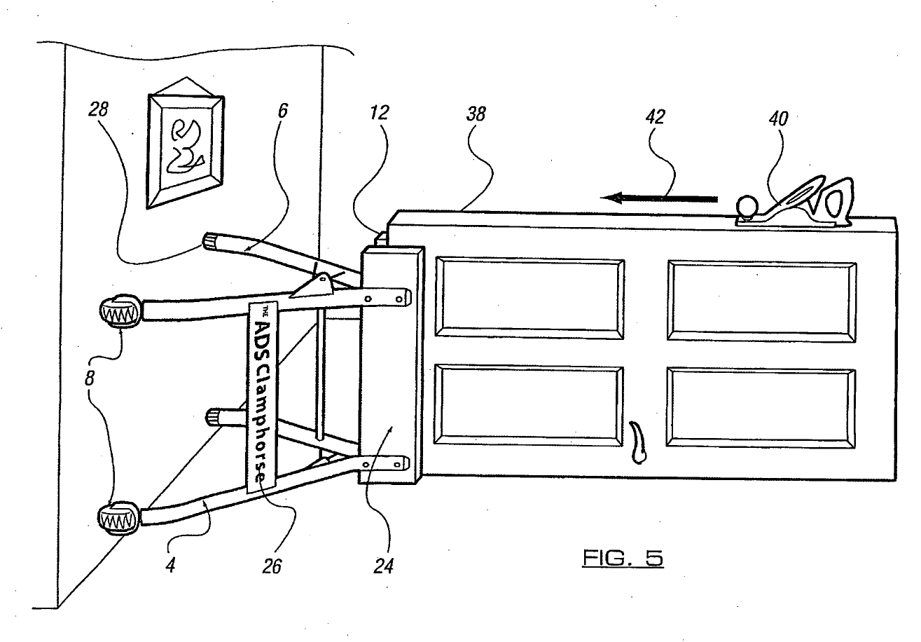

FIG. 5 illustrates a further perspective view of a gripping apparatus in use.

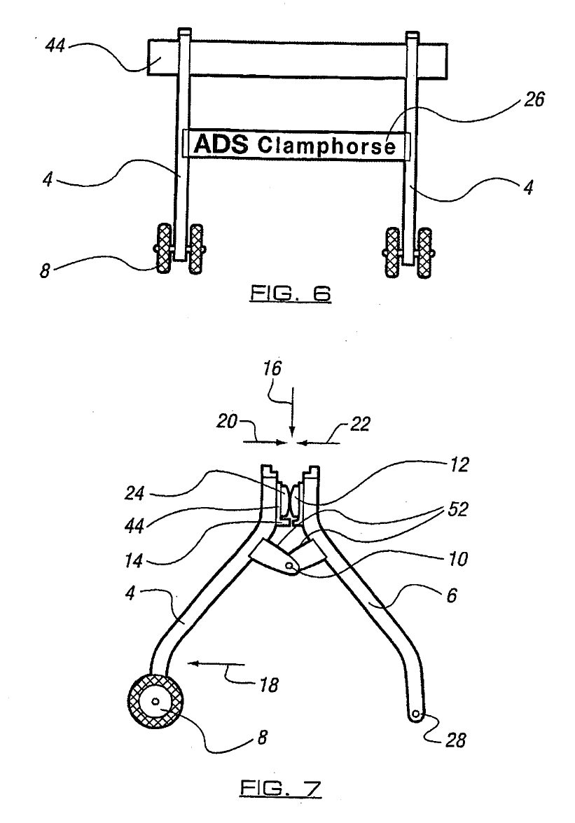

FIG. 6 illustrates a front view of a further embodiment of the invention.

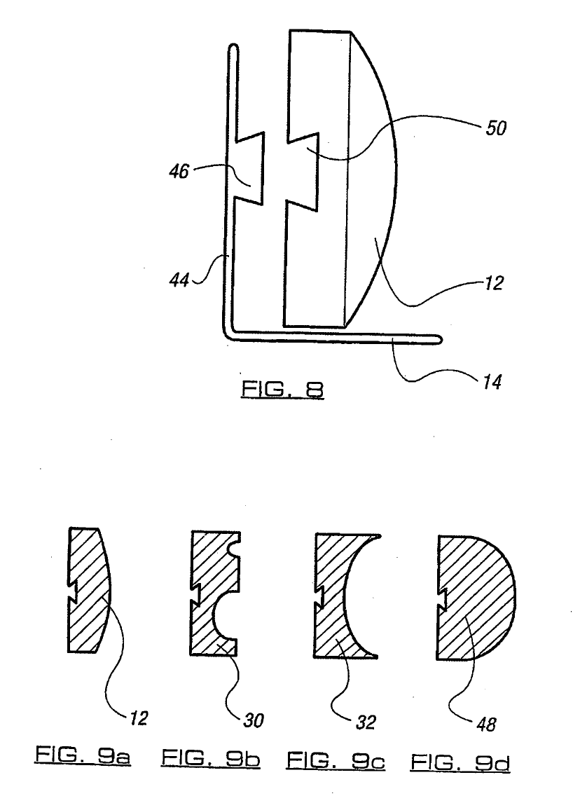

FIG. 7 illustrates a side view of the embodiment of FIG. 6 in a closed state.

FIG. 8 illustrates the jaw attachment mechanism of the embodiment of FIG. 6.

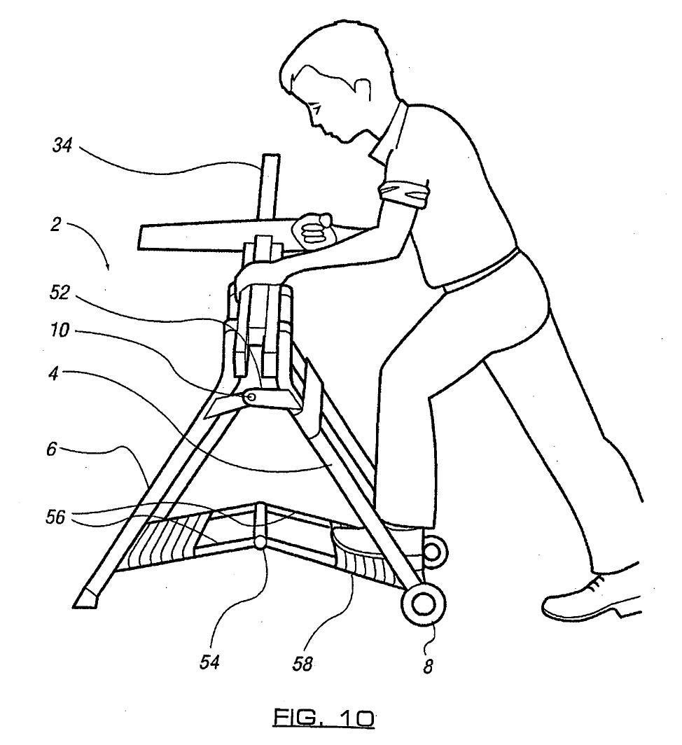

FIGS. 9a-d illustrates several interchangeable jaws for the mechanism shown in FIG. 8.

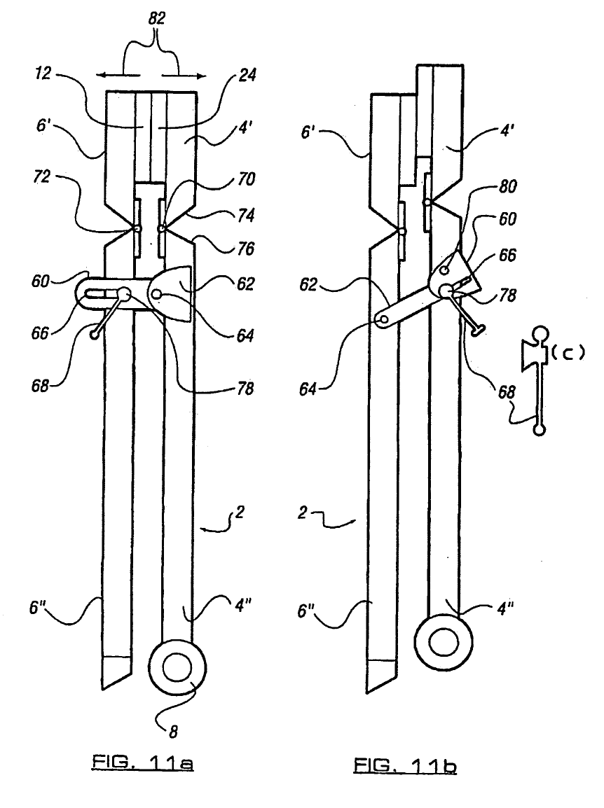

FIG. 10 illustrates a further embodiment of the apparatus with a foot plate.

FIG. 11 illustrates an alternative embodiment of the apparatus from the side (a) in the closed position (b) with the frames sliding with respect to each other (c) a locking member.

With reference to FIGS. 1-2b, there is illustrated a gripping apparatus 2 including gripping means in the form of jaws 12, 24 mounted on support means 4, 6. Support means 4 is pivotally connected to support means 6 via pivot 10. Support means 4 has a wheel 8 to allow the end of the support means 4 to move along the supporting surface. Equivalent movement of support means 6 is restricted by frictional interaction of rubber feet 28 with the supporting surface. Support means 4, 6 are constructed from a number of support members. A work support member 14 is provided to support a workpiece placed within the jaws 12, 24. A further support member 26 connects the support members of support means 4 and helps retain the structure and stability of the apparatus 2.

When placed on a supporting surface, the apparatus 2 naturally rests under its own weight in a state wherein the ends of the support means 4, 6 move apart until the jaws 12, 24 are together. When the apparatus 2 is lifted off the supporting surface, the support means 4, 6 move towards each other until they are together, and the jaws 12, 24 are moved apart. The apparatus 2 is easy to store in this folded condition.

In use, the apparatus 2 is placed on a supporting surface and then lifted slightly to open the jaws and enable a workpiece to be received. A workpiece is placed within the jaws 12, 24 and the apparatus 2 is allowed to move towards its natural state under its own weight, the jaws thereby closing on the workpiece. Downwards pressure can also be applied to the workpiece and/or the upper surface of the jaws 12, 24 by a user as indicated by arrow 16 to increase the gripping force by the jaws 12, 24 on the workpiece therebetween.

In more detail, as the apparatus 2 moves or is pushed down, the lower end of the support means 4 moves away from the end of the support means 6 as indicated by arrow 18, with a concurrent movement 20 in the opposite direction by the jaw 24 on the same support means 4, pivoting around pivoting means 10 as indicated by arrow 36. The pivot members 52 connecting the pivot 10 to the support means 4, 6 are angled downwardly towards the pivot 10, to help bias the jaws 12, 24 to a closed position and maintain the same in a gripping position even when working forces applied to the workpiece between the jaws may be acting in a direction to move the jaws apart.

There is some movement 22 of the opposite jaw 12 located on support means 6 as the apparatus 2 moves down, but this movement and concurrent opposite movement of the end of the same support means 6 is limited by friction of the same with the supporting surface.

Referring to FIG. 3a, it is shown that the jaw 12 is selectively attached to a support member of support means 6. In this example, the support member is a tubular structure and the jaw 12 is mounted on a structure including a tube with a smaller radius that fits inside the support member. A locking mechanism is not required to lock the tubes together, but may be provided by numerous known mechanisms, such as clips, bolts, screws, and/or the like.

Alternative jaws 30, 32 can be selectively fitted to the apparatus depending on the nature of the workpiece as shown in FIGS. 3 b and c. For example if the workpiece was a length of timber, jaws 12 could be used. If the workpiece was a length of rounded material such as a dowel, log or pipe, that would not be held well by jaws 12, concave jaws 32, or jaws 30 including recesses could be used. Other examples may be created as required in accordance with the workpiece.

Referring to FIG. 4, a user is shown sawing a length of wood 34, gripped by the jaws 12, 24 of the apparatus 2. Typically the user would stand on the wheeled side of the apparatus, as the sawing motion tends to create a force away from the user, and the rubber feet 28 help prevent the apparatus from moving away from the user under this force.

Referring to FIG. 5, the apparatus is shown lying on its side on the floor with the wheels 8 and rubber feet 28 in contact with a wall or other surface substantially perpendicular to the floor. A workpiece in the form of a door 38 is shown gripped between the jaws 12, 24 so that it can be worked upon using a plane 40 for example. The force created by the movement of the plane 40 along the edge of the door 38 as indicated by arrow 42 helps to provide the gripping force of the jaws 12, 24 on the door 38 in a similar manner as hereinbefore described.

Referring to FIGS. 6 and 7, an alternative configuration of the device of FIGS. 1 and 2b respectively is shown, wherein the jaw 12 is selectively attached to a backplate 44, and the backplate 44 is connected to a support member of support means 6. The backplate 44 may include an integral work support member 14 substantially perpendicular to the backplate, so as to support a workpiece placed within the jaws. A plurality of wheels 8 are provided on the support means to improve stability of the device.

In more detail with reference to FIGS. 8 and 9a-d, the backplates 44 and jaws 12, 24 are provided with means to form a sliding dovetail joint, via appropriate protrusions 46 and recesses 50. The jaws 12, 24 can be of various profiles and can be quickly interchanged, yet still be held in place when in use, to facilitate the gripping of differently shaped workpieces. The jaws can thus be combined in different ways as necessary to hold a workpiece therebetween. For example, a U-shaped gutter workpiece may be held by a combination of jaws 32 and 48.

With reference to FIG. 10, the apparatus 2 is provided with a pivoting means 54, mounted on members 56 connecting the support means 4, 6. The members 56 and pivoting means 54 increase stability of the apparatus 2. In addition the members 56 are provided with a foot plate 58 to allow a user to apply downwards force by stepping thereon, thereby increasing the grip exerted on the workpiece 34. The members 54 are angled upwards so that the same fold up between the support means 4, 6 when the apparatus is moved to the folded condition for storage.

Referring to FIG. 11a, an alternative embodiment of the invention is illustrated, wherein the top portions 6′, 4′ of the first support means 6 and/or second support means 4 are hingedly separated from the bottom portions 6″, 4″ of the same, by hingeing means in the form of hinges 70, 72.

A first pivotal member 60 is provided with a slot 66, and is connected to the first support means bottom portion 6″ via a rotatably mounted locking member 68 which passes through and can slide along the slot 66. The locking member can be a simple handle as illustrated from the side in FIG. 11c. A second pivotal member 62 is connected to the second support means bottom portion 4″, and the first and second pivotal members are pivotally connected by pivot 64. The locking member 68 can lock the bottom positions 4″, 6″ by frictionally engaging the first pivotal member 60 and/or first support means bottom portion 6″ in a particular position, for example to allow the depth of the device to be reduced, as shown.

In addition the hinges 70, 72 allow the gripping members 12, 24 to move between an open state and a closed state without concomitant movement of the bottom portions 4″, 6″, when the same are locked in position. The top portions 4′, 6′ are restricted in movement by the acute angle between the opposite faces 74, 76 of the top and bottom portions of the support means thereat. When the locking member is released and slides along the slot, the opposite faces 74, 76 of the top and bottom portions can engage and move the gripping members 12, 24 to a closed state by pivoting about one or more of the pivot points 64, 78. As both the top portions 4′, 6′ and the bottom portions 4″, 6″ can be moved to a closed position simultaneously, the depth of the apparatus 2 can be minimised.

A further variant is illustrated in FIG. 11b, where the first pivotal member 60 is rotatably mounted on the first support means bottom portion 6″ via a pivot 80. A locking member 68 passes through and can slide along the slot 66 provided on the first pivotal member 60. The second pivotal member 62 is pivotally connected to the second support means bottom portion 4″ by pivot 64, and the first pivotal member 60 via pivot 78 of locking member 68. This allows the support means to slide over each other and reduces how far the pivotal members 60, 62 protrude, such that the overall depth of the apparatus 2 is minimised.

It will be appreciated by persons skilled in the art that the present invention also includes further additional modifications made to the device which does not effect the overall functioning of the device, such as the provision of decoration, a fabric or plastic covering to provide improved aesthetic appearance, and/or the like.

1. A gripping apparatus comprising two or more gripping members each mounted on support means at a first end thereof, and pivoting means connecting the support means at a location offset from the gripping members, such that the gripping members are moved towards each other to exert a grip on a workpiece positioned between the same as the distal ends of the support means are moved apart.

2. A gripping apparatus according to claim 1 characterised in that the pivoting means includes pivotally connected members which are angled downwardly towards the distal ends of the support means at least when the gripping members are in a closed condition.

3. A gripping apparatus according to claim 1 characterised in that the gripping members move towards each other when placed on the supporting surface under the weight of the apparatus and/or when a downwards or other force is applied to the apparatus.

4. A gripping apparatus according to claim 1 characterised in that the gripping members move apart from each other when the apparatus is lifted from the supporting surface.

5. A gripping apparatus according to claim 1 characterised in that the apparatus can be lifted to move apart the gripping members, without removal from a supporting surface, to allow the insertion of a workpiece between the gripping members.

6. A gripping apparatus according to claim 1 characterised in that the workpiece is gripped by the gripping members under the weight of the apparatus and/or workpiece.

7. A gripping apparatus according to claim 1 characterised in that the pivoting means includes a means to allow a user to apply an external force on the gripping members towards each other.

8. A gripping apparatus according to claim 7 characterised in that the means to allow a user to apply an external force is a plate angled towards the gripping members.

9. A gripping apparatus according to claim 1 characterised in that the distal ends of the support means are in contact with a supporting surface at least during the gripping of the workpiece.

10. A gripping apparatus according to claim 1 characterised in that movement means are provided on the distal end or ends of at least one of the support means to allow movement of the same along a supporting surface.

11. A gripping apparatus according to claim 10 characterised in that the movement means are any or any combination of wheels, rollers, bearings, and/or slides.

12. A gripping apparatus according to claim 1 characterised in that resistance means are provided on the distal end or ends of at least one of the support means to engage a supporting surface and restrict the movement apart of the support means.

13. A gripping apparatus according to claim 12 characterised in that the resistance means includes any or any combination of rubber feet, locks, screws, bolts, weights, abrasive materials, and/or protrusions.

14. A gripping apparatus according to claim 1 characterised in that the support means includes one or more support members in the form of any or any combination of tubes, struts, and/or other resilient members.

15. A gripping apparatus according to claim 1 characterised in that one or more work support members are provided adjacent the gripping members to support the workpiece when not gripped by the gripping members.

16. A gripping apparatus according to claim 15 characterised in that the one or more work support members are extendable.

17. A gripping apparatus according to claim 1 characterised in that the gripping members are detachably connected to the support means.

18. A gripping apparatus according to claim 17 characterised in that the gripping members and support means are provided with attachment means and/or complimentary receiving means to allow the gripping members to be connected to the support means.

19. A gripping apparatus according to claim 17 characterised in that the attachment means and receiving means are tubular, and/or connect together concentrically.

20. A gripping apparatus according to claim 17 characterised in that the attachment means and receiving means connect together in a dovetail joint, such that the gripping members can be slidably mounted on the support members.

21. A gripping apparatus according to claim 17 characterised in that the attachment means and receiving means include any or any combination of screws, nuts, bolts, latches, wedges, and/or locks.

22. A gripping apparatus according to claim 1 characterised in that the gripping members can be provided in different shapes and materials to suit the shape and nature of the workpiece.

23. A gripping apparatus according to claim 1 characterised in that the pivoting means includes a first member connected to first support means via locking means, a second member connected to second support means, the first member pivotally connected to the second member.

24. A gripping apparatus according to claim 23 characterised in that the locking means comprises a slot in the first member and a locking member capable of extending through and sliding along the slot, for locking at least part of the support means in a particular position.

25. A gripping apparatus according to claim 23 characterised in that the top portions of the first and/or second support means, which include gripping members, are hingedly separated from the bottom portions, which include the pivoting means, by hingeing means.

26. A gripping apparatus according to claim 25 characterised in that when at least part of the support means is locked by the locking means, the hingeing means allows the gripping members to move between an open state and a closed state without concomitant movement of the bottom portions.

27. A gripping apparatus according to claim 25 characterised in that the opposite faces of the top and bottom portions are angularly adjustable with respect to each other, and can engage to move the gripping members to a closed state.
